(19) United States
(12) Patent Application Publication
(10) Pub. No.: US 2026/0145493 A1
(43) Pub. Date: May 28, 2026

(54) DOOR ASSEMBLY AND DOOR MODULE OF A MOTOR VEHICLE

(71) Applicant: Brose Fahrzeugteile SE & Co. Kommanditgesellschaft, Bamberg, Bamberg (DE)

(72) Inventors: Andre CARL, Ebersdorf (DE); Julian SCHMITT, Reckendorf (DE); Dominik HOFMANN, Baunach (DE); David KRAUSE, Ebelsbach (DE); Matthias HEPPNER, Burgkunstadt (DE)

(21) Appl. No.: 19/395,742

(22) Filed: Nov. 20, 2025

(30) Foreign Application Priority Data
Nov. 26, 2024 (DE) 202024106846.7

(51) Int. Cl. B60J 5/04; B60R 16/02

(52) U.S. Cl. CPC B60J 5/0412; B60R 16/0215

(57) ABSTRACT

A door assembly of a motor vehicle door, having an inner door part with a lateral frame portion and a door module as well as a wiring harness pre-mounted thereon, wherein on the lateral frame part a recess is provided into which the wiring harness lies or can be inserted.

### CROSS-REFERENCE TO RELATED APPLICATIONS

This application claims priority pursuant to 35 U.S.C. 119(a) to German Application No. 202024106846.7, filed Nov. 26, 2024, which application is incorporated herein by reference in its entirety.

### FIELD

The invention relates to a door assembly of a motor vehicle, having a frame-like inner door part and a door module mounted or mountable on the inner door part. The invention further relates to a door module for such a door assembly and to a vehicle door with such a door assembly.

### BACKGROUND

A vehicle door of a motor vehicle (motor vehicle door) typically has an inner door part, also referred to as a door shell, which is usually frame-like, and an outer door part (outer door panel, outer panel) forming the outer door skin, as well as, if applicable, an inner door panel or an inner door lining. The inner door part or the door shell connected to the outer door panel typically has two spaced-apart, opposite side frame portions and a railing portion connecting them, as well as a lower sill portion (door bottom). Between the inner door part and the outer door panel, a cavity is formed as an assembly space in which functional elements of the vehicle door, such as components of a window lifter, a door lock, an airbag sensor, or the like are arranged.

Moisture can penetrate into the cavity, also referred to below as the door interior, between the outer door part and the inner door part, for example via a door sill slot through which a window pane closing the window opening of the vehicle door is guided. Therefore, the cavity is divided, by a wet-dry space separation, into a wet space facing the vehicle environment or the door outer part (wet space side) and a dry space facing the vehicle interior or the interior lining (dry space side).

In the following, information is provided regarding the spatial directions, in particular in a coordinate system of the vehicle (vehicle coordinate system) with regard to an exemplary installation situation of a door module in a side door. The abscissa axis (X-axis, X-direction) is oriented along the vehicle's longitudinal direction (direction of travel), the ordinate axis (Y-axis, Y-direction) along the vehicle's transverse direction, and the applicate axis (Z-axis, Z-direction) along the vehicle height.

The railing portion of the door assembly or vehicle door, oriented in the longitudinal direction of the vehicle (X direction in the vehicle coordinate system), together with the side frame portions oriented in the direction of the vehicle height (Z direction in the vehicle coordinate system) and the sill portion connecting them at the underside of the door and running in the X direction, defines a frame portion (door portion) of the inner door part (door shell). One of the side frame portions, which faces the A-pillar of the vehicle, typically has door hinges or hinge parts with which the vehicle door is hinged to the vehicle or to the vehicle body. A door lock is accessible via an opening in the opposite side frame portion, which faces the B-pillar of the vehicle.

The frame or module portion of the door assembly or the vehicle door is at least partially, preferably completely, covered with a plate-like or plate-shaped aggregate carrier (door module carrier, functional carrier, base carrier) when the vehicle door is assembled. Various functional components of the vehicle door, for example components of the window lifter, a drive device, a side airbag module, a loudspeaker, an operating unit or the like, can be pre-mounted on the unit carrier. The pre-mounted unit carrier, hereinafter referred to as the door module, also serves in particular to separate the wet space formed between the outer door panel and the door module from the dry space formed between the door module (door module carrier) and the inner door lining of the vehicle door, in particular for moisture-sensitive functional components of the door module or the vehicle door.

To contact and supply the functional components, the vehicle door or the door module can be connected to a vehicle electrical system using a door disconnect plug of a wiring harness of a connecting cable or cable harness (cable set). The door disconnect plug forms in particular a connecting component which is positioned in the region of the door hinges and is provided to establish or disconnect the electrical connection between the vehicle door and the vehicle electrical system. Such a door disconnect plug enables quick and safe disconnection of electrical cables, for example for maintenance work, repairs or replacing the door, without affecting the entire electrical system of the vehicle. The door disconnect connector, which is intended to ensure reliable transmission of signals and energy between the vehicle door and the vehicle body, usually contains a plurality of connections for different electrical functional components of the door, such as the window lifter, the exterior mirror adjustment, the door lock mechanisms, and security systems.

During assembly, for example when the door disconnect plug is to be routed to the door module by means of a main wiring or cable set designed as a cable harness or the like and is to be contacted with the door module, a sleeve-like or tube-like grommet of the main wiring harness standardly has to be routed through a hole in the frame-like door shell or door inner part at a door disconnection point, typically in a laborious manual process. Also, due to a given installation position or final assembly position of individual components, it is often necessary to manually reach behind the inner door part during the assembly process, which requires an undesirably complex assembly process.

### SUMMARY OF THE INVENTION

The invention is based on the object of specifying a door assembly for a motor vehicle which is suitable for a door mounting which can be automated as far as possible, in particular in robot-controlled fashion. Furthermore, a door module particularly suitable for this purpose is to be specified.

The door assembly has a frame-like inner door part or inner door panel with a side frame portion, hereinafter also referred to as A-pillar side frame portion, and a door module mounted or mountable on the inner door part. The door assembly has a wiring or cable harness pre-mounted on the door module, with a recess provided on the side frame part of the inner door part into which the wiring harness is or can be inserted. The recess is made between adjacent hinge bands, preferably as an embossing, in the (A-pillar-side) frame portion. The door module has a wet space side and a dry space side, on which a wiring harness is mounted on a cover element.

The invention is based on the idea of laying the main wiring or cable harness directly in the dry space based on a surface-mounted installation concept in the region of the door separation point, avoiding a passage into the wet space. The cable harness should be mounted completely in the transverse direction of the vehicle (Y-direction in the vehicle coordinate system) and the cable harness should be able to be routed behind a main door seal. In addition, the cable harness or a cable guide should be mountable together with the door module on the door inner part (door shell).

According to an expedient embodiment, the recess is designed as a bead-like cable duct. In other words, the inner door part or panel, particularly in the region of a main door seal, is embossed to accommodate the wiring or cable harness at least partially. Advantageously, the recess is guided over a frame rabbet of the lateral frame portion of the door inner part, in particular one which is approximately Z-shaped in cross section.

The recess is suitably made close to the door module. The recess can be at a distance from the door module. Preferably, the recess directly adjoins the door module. Preferably, the recess should be covered by an interior door lining mounted on the door assembly.

In a particularly advantageous embodiment, the cable harness is arranged on a cover element or integrated into it, wherein the cover element covers the recess or the bead-like cable duct at least partially or in portions, preferably completely.

The cover element is suitably attached to or on a dry space side of the door module. The cover element is particularly advantageously a one-piece or one-part component of the door module. The shape of the cover element is particularly expediently adapted to the outer contour of the side frame portion or its frame rabbet.

In the assembled state, the recess or the cover element is preferably guided under a main door seal, in particular running transversely thereto. In other words, the main door seal on the lateral frame portion spans the recess, which is advantageously covered by the cover element, with the wiring or cable harness located therein in the direction transverse to the main direction of extension of the cover element or the recess.

### BRIEF DESCRIPTION OF THE INVENTION

An embodiment of the invention is explained in more detail below with reference to a drawing. In the figures:

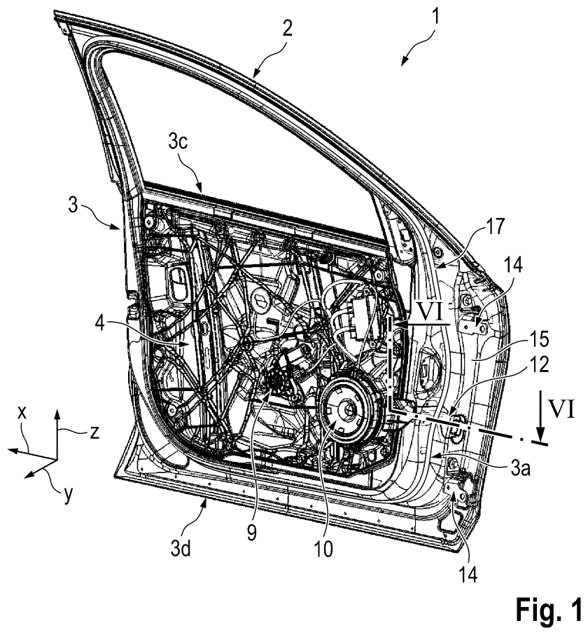

FIG. 1 shows a perspective view of a door assembly with a frame-like inner door part with a door module mounted thereon with pre-mounted components and with a cover element guided over a frame portion on the A-pillar side,

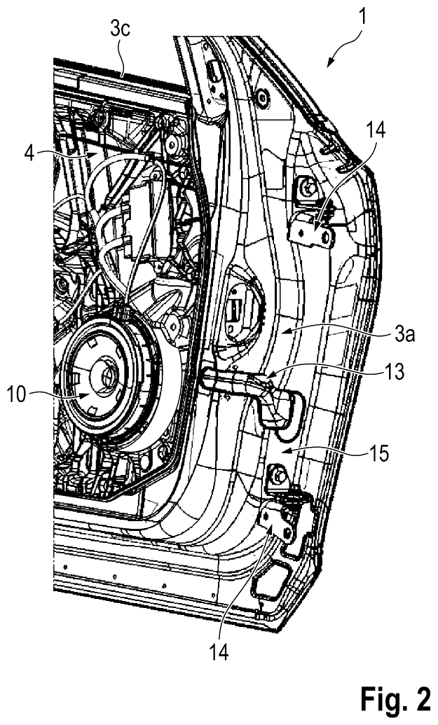

FIG. 2 shows a partial perspective view of the door assembly according to FIG. 1 with a view into a bead-like recess for a cable harness guided in the cover element,

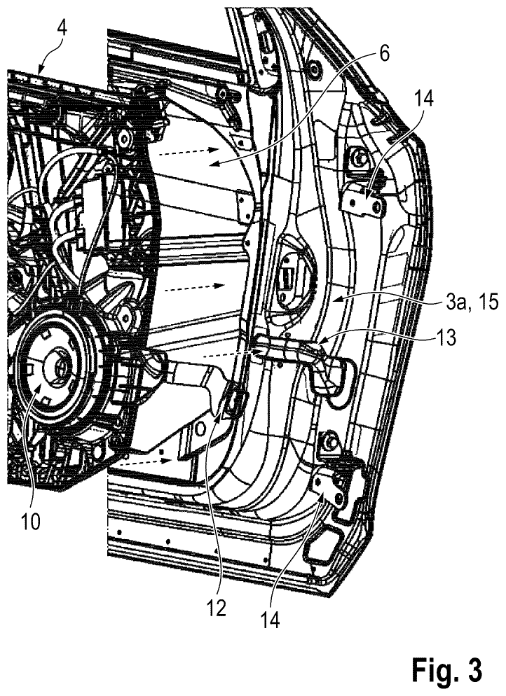

FIG. 3 shows a portion of an exploded view of the door assembly according to FIG. 1 in an assembly state with the cover element arranged on the door module for the bead-like recess in the door inner part,

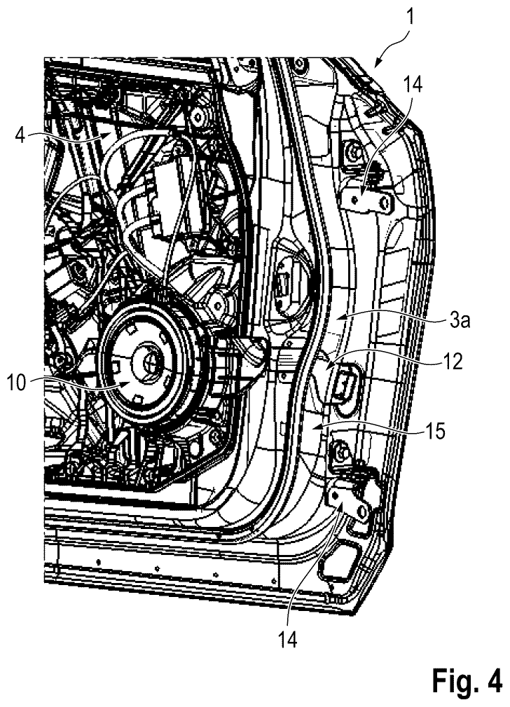

FIG. 4 shows, in a representation according to FIGS. 2 and 3, the assembly state of the door module on the door inner part without the main door seal in the frame portion,

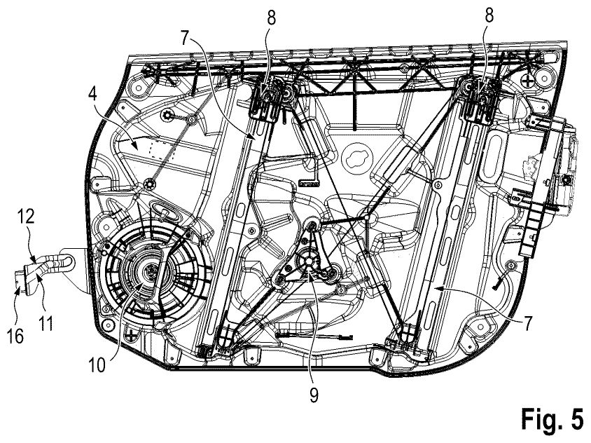

FIG. 5 shows a plan view of a wet space side of the door module with mounted cover element and cable harness arranged thereon, and

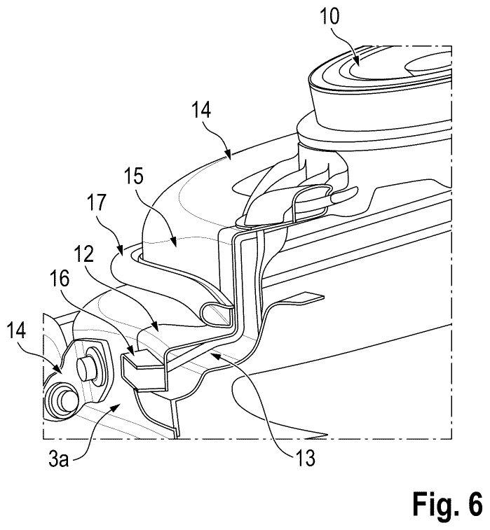

FIG. 6 shows, in a sectional view along the line VI-VI in FIG. 1, the mounted cover element with the cable harness guided on it and in the bead-like recess of the door inner part.

### DETAILED DESCRIPTION OF THE INVENTION

Corresponding parts are provided with the same reference numbers in all figures.

Information regarding the spatial directions is given in the vehicle coordinate system with regard to the orientation of a side door of a motor vehicle, with the X-direction being oriented along the vehicle's longitudinal direction (direction of travel), the Y-direction being oriented along the vehicle's transverse direction, and the Z-direction being oriented along the vehicle's height.

FIG. 1 shows a door assembly 1 as part of a vehicle door designed as a frame door in the exemplary embodiment with a frame (door frame, window frame) 2. The door assembly 1 has a frame-like door inner part 3, also referred to as the door shell, with lateral frame portions 3a, 3b oriented in the Z direction and a railing portion 3c connecting these and running in the X direction, as well as a lower sill portion (door bottom) 3d running in the X direction. The frame portion 3 a faces the A-pillar and the frame portion 3b faces the B-pillar of the vehicle 3b. The door assembly 1 also has a door module 4 with a plate-like aggregate carrier 5 that is attached or mountable to the door inner part 2. When installed, the door module 4 or the unit carrier 5 implements a wet/dry space separation within the vehicle door.

With particular reference to FIG. 3, a door inner or assembly space 6 forming the wet space is formed between the door inner part 3 and a door outer panel (not shown or not visible). FIGS. 1 to 4 show the door module 4 with a view of the dry space side, and FIG. 5 shows the door module 4 with a view of the panel side facing the wet space or the door interior or assembly space 6 of the door assembly 1 or the vehicle door.

In the door interior or assembly space 6 of the door assembly 1, functional elements of the vehicle door (some of which can also be seen in FIG. 5) are arranged, such as two parallel guide rails 7 with rail sliders 8 guided so as to slide thereon and having a driver function for a window pane (not shown) that can be retracted into the (door) frame 2, as well as an electromotive actuator 9 of a (cable) window lifter provided for adjusting the window pane between an open position and a closed position, and a loudspeaker 10.

Also with regard to FIG. 6, the door module 4 has a pre-mounted wiring or cable harness 11 and a cap-like cover element 12, on which portions of the cable harness 11 are guided and held. A bead-like recess 13 is provided on the A-pillar-side frame portion 3a of the door inner part 3, in which recess the cable-like wiring harness 11 lies or can be placed. The channel-like recess 13, hereinafter also referred to as the cable duct, is embossed into the frame section 3a between hinge bands 14 of the door assembly 1 that are adjacent on the A-pillar side, and is provided in a frame rabbet 15 having an approximately Z-shaped cross section.

The recess 13, which acts as a cable duct and partially receives the wiring or cable harness 11, is made close to the door module 4 and preferably extends up to the door module 4. The cover element 12 with the cable harness 11 lying in the cable duct or in the recess 13 with the disconnecting plug 16 provided at the end thereof is arranged exclusively on the dry space side of the door assembly 1 and of the door module 4.

Advantageously, the cover element 12 is formed integrally (in one part) with the door module 4. In other words, the cover element 12 is preferably integrally formed onto the door module 4 or onto the aggregate carrier 5. The shape of the cover element 12 is adapted to the outer contour of the lateral frame portion 3a or its frame rabbet 15, i.e., it is approximately Z-shaped in cross section. In particular, the recess 13 or the cover element 12 should be covered by an inner door lining (not shown here) mounted on the dry space side of the door assembly 1.

In the assembled state shown in FIG. 1, the recess 13 and the cover element 12 with integrated cable harness 11 are guided under a main door seal 17 and run in the X direction and transversely to the portion of the main door seal 17 running in the Z direction. In the assembled state, the main door seal 17 on the lateral frame portion 3a spans the cover element 12 and the recess 13 covered thereby with the wiring or cable harness 11 lying therein.

In summary, the invention relates to a door assembly 1 of a motor vehicle door, having an inner door part 3 with a lateral frame portion 3a and a door module 4 as well as a wiring harness 11 pre-mounted thereon, wherein a recess 13 is provided on the lateral frame part 3a of the door inner part 3, into which recess the wiring harness 11 lies or can be inserted.

The inventive concept is based on laying the main wiring or cable harness 11 in the manner of a surface-mounted laying in the region of a door separation point directly in the dry space, avoiding a passage into the wet space. Here the cable harness 11 is mounted completely in the Y direction (vehicle transverse direction) and is routed behind or under the main door seal 17. In addition, the cable harness 11 guided on the cover element 12 can be mounted automatically on the door inner part (door shell) 3 together with the door module 4 without the use of a cable feedthrough or grommet for the cable harness 11.

The claimed invention is not restricted to the embodiments described above. Rather, other variants of the invention can likewise be derived therefrom by the person skilled in the art within the scope of the disclosed claims, without departing from the subject matter of the claimed invention. In particular, all individual features described in connection with the various embodiments can also be combined with one another in other ways within the scope of the disclosed claims, without departing from the subject matter of the claimed invention.

### LIST OF REFERENCE NUMBERS

1 Door assembly
2 Door/window frames
3 Door inner part
3a (A-pillar side) frame portion
3b (A-pillar side) frame portion
3c Railing portion
3d Sill portion
4 Door module
5 Aggregate carriers
6 Door interior/assembly space
7 Guide rail
8 Rail slider
9 Actuator
10 Speaker
11 Wiring/cable harness
12 Cover element
13 Recess/cable duct
14 Hinge band
15 Frame rabbet
16 Disconnect plug
17 Main door seal

What is claimed is:

1. A door assembly of a motor vehicle door, having a frame-like inner door part with a lateral frame portion and a door module mounted or mountable on the inner door part and a wiring harness pre-mounted thereon, wherein a recess is provided on the lateral frame part of the inner door part between adjacent hinge bands, into which recess the wiring harness lies or can be inserted.

2. The door assembly according to claim 1, wherein the recess is designed as a bead-like cable duct or is introduced as an embossing into the frame portion of the door inner part.

3. The door assembly according to claim 1, wherein:
the recess is made close to the door module, and/or the recess adjoins the door module, in particular directly.

4. The door assembly according to claim 1, wherein the recess is guided over a frame rabbet of the lateral frame portion (3a) of the door inner part.

5. The door assembly according to claim 1, wherein the wiring harness is arranged on a cover element or integrated into it.

6. The door assembly according to claim 5, wherein the cover element is fastened to or on a dry space side of the door module or is formed integrally with the door module.

7. The door assembly according to claim 1, wherein the recess or the cover element is guided under a main door seal, in particular transversely thereto.

8. The door assembly according to claim 1, wherein the shape of the cover element is adapted to the outer contour of the lateral frame portion or its frame rabbet.

9. A door module for a door assembly according to claim 1, having a wet space side and a dry space side, on which a wiring harness is mounted on a cover element.

10. A vehicle door of a motor vehicle, having a door assembly according to claim 1.
